(19) United States
(12) Patent Application Publication
(10) Pub. No.: US 2008/0148642 A1
(43) Pub. Date: Jun. 26, 2008

(54) Arc resistant switchgear door and frame assembly, through the door racking system, and air cooling and ventilation system

(76) Inventor: Alain Herve Mathieu, Winnipeg (CA)

Correspondence Address: RICHES, MCKENZIE & HERBERT, LLP, SUITE 1800, 2 BLOOR STREET EAST, TORONTO, ON, M4W 3J5, omitted

(21) Appl. No.: 11/529,232

(22) Filed: Sep. 29, 2006

(51) Int. Cl. E05C 9/00

(52) U.S. Cl. 49/395

(57) ABSTRACT

An arc-resistant door and casing design having a frame structure covered by a skin enhancing protection from damage and injury resulting from explosion and internal electrical fault. Thru-the-door breaker operation is provided by a racking mechanism having a threaded shaft operated by a user outside the door. An air cooling system for an arc-resistant switchgear cubicle having at least one insulated ventilation shaft longitudinally at a side of the cubicle whereby cooling air is drawn into the shaft from an inlet at a top end of the shaft and enters into the cubicle through an outlet of the shaft provided at a bottom area of the cubicle by convection. The cooling air mixes with warm air inside the cubicle and hot exhaust air flows upward to exit through at least one blow vent at a top area of the cubicle.

### FIELD OF THE INVENTION

This invention relates to an arc-resistant switchgear door and frame assembly and a “through-the-door” racking system, and an air cooling and ventilation system for an arc-resistant switchgear cubicle.

### BACKGROUND OF THE INVENTION

Recent safety standards mandate additional personal safety measures be taken to protect workers and prevent injury that may be caused by electrical faults in medium voltage electrical cabinets. An internal electrical fault in a switchgear cabinet generates a large quantity of hot gas and vaporized material, some of which is toxic and harmful to workers that may be in or around the cabinet. The electrical fault acts much like an explosion and the heat intensity at the centre of the arc can be over 10,000 degrees Fahrenheit. Such explosions in standard electrical equipment cause a lot of damage to the cabinet, including flying parts or superheated particles, and the emission of hot gases is harmful to workers.

Known art door securing mechanisms use first and second tabs which are longitudinally positioned at the sides of the frame and door, respectively. The first and second tabs can be vertically translated into an overlapping arrangement when the door is swung on its hinges into a secure position. While the overlapping tabs provide some resistance to the door being blown off the frame as a result of the force caused by explosive gases produced by an arcing fault, the tabs do not “lock” with each other. The tabs are merely aligned in an overlapping arrangement and are susceptible to bending in the same direction when a sufficient force is applied to the door.

Another door securing mechanism uses a pin and hole arrangement. A pin is positioned at the edge of a door and can be fitted into a hole in a plate provided in a door casing to lock the door when closed. However, such a securing mechanism is disadvantageous as the pin is subjected to shearing forces when a corresponding force is applied to the face of the door in the event of an electrical fault.

Therefore, there is a need to provide means to contain the electrical fault safely and to redirect its force such that it will not harm an operator and also to minimize the resulting damage.

There is also a need to enable a user to operate breakers through a door to an electrical cabinet without having to open the door or expose the user to a harmful electrical fault explosion.

A majority of existing switch gear cubicles require that the main breaker which connects and disconnects to the main high voltage bus be installed with the cubicle door open thereby exposing an operator to a higher risk of injury due to an inadvertent arcing event. Thus, a “through-the-door” racking system enables the connection and disconnection procedure to be completed with the cubicle door closed thereby enhancing protection of the operator. The “through-the-door” racking system also provides a tilting feature that enables connection and disconnection of a rack end of a racking shaft to a breaker. When the racking shaft is connected to a breaker, the breaker can be pushed or pulled in or out of position.

Such a “through-the-door” racking system can either be incorporated in a door to a switch gear cabinet, such as the door enhanced securing mechanism described above, or can be a retrofit racking system installed in an existing door enabling breakers to be modified to allow for the connection or disconnection procedure to be completed with the cubicle door closed.

Furthermore, for safety purposes, arc-resistant switchgear cubicles require that, under a fault condition, hot gases are prevented from being emitted from the cubicle. The most reliable method to ensure that this condition is met is to not have any air vents in the various access doors and panels to the cubicle.

As the electrical equipment in the cubicle generates heat, the need for cooling an arc-resistant switchgear cubicle has always resulted in a conflict with the structural design process. In the past, manufacturers have resolved this problem by designing collapsible air vents or incorporating elaborate shrouds which permit cooling of a cubicle; however prohibit venting of hot and harmful gases. However, the applicant has appreciated that the prior art constructions introduce a weak point in the art-resistant capabilities of the cubicle. As a result, the prior art constructions result in more elaborate contraptions which require mechanical moving parts.

### SUMMARY OF THE INVENTION

The present invention provides an arc resistant door which shuts into a door casing at an access opening to an electrical cabinet. The door comprises a reinforced structure including an internal frame and a skin. The frame and skin design provides a reinforced door which is capable of withstanding a great amount of force without using an excessive amount of material. To protect the hinge side of the door from the force of an explosion and flying material, an overlapping angle can be provided on the door casing and wrapped around part of a hinge side of the casing. In addition, unique hook style “gang” operated latches hook themselves into reinforcing pins at a latch side of the casing to add additional strength to the frame and resist bending of the door and/or frame in the event of an explosion. By providing the unique frame on skin design, forces are transferred to the frame rather than the steel skin which is not as strong. Because of the reinforcing features mentioned herein, the expulsion of hot gasses is limited by maintaining a sealed front compartment.

The present invention also provides a racking mechanism to accommodate operation of various breakers without opening the equipment access door. The racking mechanism can be retrofitted to an existing access door. In one aspect, the racking mechanism uses a door mounted screw that interfaces with the breaker inside the cubicle. Such a mechanism allows a circuit breaker to be changeably withdrawn or connected to a live bus while maintaining the Arc-resistant barrier intact. The user is safely protected by the door from any flying parts, hot gases and harmful vapours caused by an explosion.

The present invention also provides an arc-resistant switchgear cubicle which provides for cooling of the cubicle while maintaining the structural integrity of the cubicle to better protect users against harm during a fault condition in the switchgear cubicle. The applicant has appreciated that the introduction of insulated vents, provided at least at one side of the cubicle, advantageously provides incoming air which is cooler than the exhaust air due to the insulation of the vent. Also, by introducing the cooler air into a lower portion of the cubicle, the cool air will mix with the hot air in the cubicle and the resulting warmer exhaust air can be vented through a top of the cubicle. Thus, the cooling air flow is created by a convection flow of air through the cubicle.

Furthermore, each section of the cubicle can be isolated from another section and multiple air cool vents can be introduced for each section. Each of the intake vents can be separated from another intake vent to maintain a maximum flow rate within each section of the cubicle.

The features described herein can be altered as to size and material gauge to accommodate various standard electrical parameters such as voltage class and interrupting rating and current carrying capacity of various breakers and individual specifications.

The features described herein can be incorporated as new equipment in a new application, and can also be installed with existing equipment in a retrofit application, for example to meet new safety standards.

It is an object of this invention to provide means to contain an electrical fault safely and to redirect its force to protect an operator and minimize any resulting damage.

It is a further object of this invention to provide ventilation for an arc-resistant switchgear cubicle, which does not require fans or other means to create air flow, while maintaining the structural integrity of the cubicle to resist failure during an arc fault.

In one aspect, the present invention resides in a door for sealing an opening to an electrical panel, said door comprising a supporting frame and a door skin connected to a side of the supporting frame, the supporting frame comprising: an elongated hinge side member having a top end and a bottom end, an elongated latch side member having a top end and a bottom end, a top member having a proximal end and a distal end, the top member proximal end being connected to the top end of the hinge side member and the top member distal end being connected to the upper end of the latch side member, and a bottom member having a proximal end and a distal end, the bottom member proximal end being connected to the bottom end of the hinge side member and the bottom member distal end being connected to the bottom end of the latch side member, the door further comprising a latching mechanism to lock the door to a door casing, the latching mechanism comprising at least one latch hook having a latch body and a latch hook end, the latch body being connected to a latching mechanism base at a first side of the latch hook and connected to a linkage member at a second side of the latch hook at a position on the latch body spaced laterally from the attachment to the latching mechanism base so that movement of the linkage member in an upward or downward direction causing the latch hook to pivot through a plane parallel to a to engage or disengage a pin provided in a channel of a door frame, the latching mechanism base being mounted to the door at or near the hinge side member with at least one mounting latch plate and a fastener, and the door further comprising a door handle having a handle lever and a post orthogonally connected thereto, the door handle being mounted on the door skin with the elongated post passing through an aperture in the door skin and an aperture in the latching mechanism base, the post mating with a hole in a post plate which is connected to the linkage member at a position above or below a position of an attachment of the latch hook to the linkage member, such that turning the door handle lever moves the linkage member to selectively engage or disengage the at least one latch hook on a respective at least one pin of a door case.

In another aspect, the present invention resides in a racking mechanism mountable to a door comprising: a threaded shaft having a racking end and a user end, and a mounting plate, the mounting plate having an aperture with a threaded hub positioned there through, the threaded shaft being movable through the hub to extend the racking end closer and further from the mounting plate.

In another aspect, the present invention resides in a racking mechanism mountable to a door comprising: a threaded shaft having a racking end and a user end, the racking end having a socket adapter connected thereto and the user end having a socket adapted to connect with a wrench; a first mounting plate having at least one mounting hole and a second mounting plate having at least one mounting hole, the first and second mounting plates being hingedly connected; a hollow cylindrical hub support is fixed to the first mounting plate and a hub hole is formed through the first mounting plate so that the hub support is accessible at both ends and provides a hollow cylindrical channel; and a cylindrical hub having a threaded core is threadably movable on the threaded shaft and the hub is securable within the hollow cylindrical channel of the hub support.

In a further aspect, the present invention resides in a door for sealing an opening to an electrical panel, said door comprising a supporting frame and a door skin connected to a side of the supporting frame, the supporting frame comprising: an elongated hinge side member having a top end and a bottom end, an elongated latch side member having a top end and a bottom end, a top member having a proximal end and a distal end, the top member proximal end being connected to the top end of the hinge side member and the top member distal end being connected to the upper end of the latch side member, and a bottom member having a proximal end and a distal end, the bottom member proximal end being connected to the bottom end of the hinge side member and the bottom member distal end being connected to the bottom end of the latch side member, the door further comprising a latching mechanism to lock the door to a door casing, the latching mechanism comprising at least one latch hook having a latch body and a latch hook end, the latch body being connected to a latching mechanism base at a first side of the latch hook and connected to a linkage member at a second side of the latch hook at a position on the latch body spaced laterally from an attachment to the latching mechanism base so that movement of the linkage member in an upward or downward direction causing the latch hook to pivot through a plane parallel to a to engage or disengage a pin provided in a channel of a door frame, the latching mechanism base being mounted to the door at or near the hinge side member with at least one mounting latch plate and a fastener, and the door further comprising a door handle having a handle lever and a post orthogonally connected thereto, the door handle being mounted on the door skin with the elongated post passing through an aperture in the door skin and an aperture in the latching mechanism base, the post mating with a hole in a post plate which is connected to the linkage member at a position above or below a position of an attachment of the latch hook to the linkage member, such that turning the door handle lever moves the linkage member to selectively engage or disengage the at least one latch hook on a respective at least one pin of the door case, the door further having a threaded aperture through which a racking mechanism is positioned, the racking mechanism comprising a threaded shaft having a racking end and a user end, the racking end having a socket adapter connected thereto.

In a further aspect, the present invention resides in an air cooling system for an arc-resistant switchgear cubicle, wherein: at least one insulated ventilation shaft is positioned longitudinally at a side of the cubicle, the at least one insulated ventilation shaft having an inlet at an upper end and an outlet at a lower end; at least one blow vent is provided at a top of the cubicle; and whereby cold air is drawn into the cubicle through the inlet of the at least one insulated ventilation shaft and enters the cubicle through the outlet, and warm air is exhausted from the cubicle through the at least one blow vent, the flow of air being generated by convection current.

In yet a further aspect, the present invention resides in an air cooling system for an arc-resistant switchgear cubicle having three sections formed by vertically disposed walls within the cubicle, wherein: each section has two insulated ventilation shafts, each shaft being positioned longitudinally at each side wall of the section, each insulated ventilation shaft having an inlet at an upper end and an outlet at a lower end; one blow vent is provided at a top surface of the section; and whereby cold air is drawn into each cubicle section through the inlets of the insulated ventilation shafts and enters the cubicle section through the outlets, and warm air is exhausted from each cubicle section through the blow vent, the flow of air being generated by convection current.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a door and frame design of the present invention;

FIG. 2 shows the door shown in FIG. 1;

FIG. 3 shows the frame shown in FIG. 1;

FIG. 4 shows the latching mechanism of the present invention;

FIG. 5 shows an exploded view of the latching mechanism shown in FIG. 4;

FIG. 6 shows a latch hook of the latching mechanism of the present invention;

FIG. 7 shows a racking mechanism of the present invention;

FIG. 8 shows a racking mechanism mounting plate with a hinge in perspective view;

FIG. 9 shows the racking mechanism mounting plate of FIG. 8 from a top view;

FIG. 10 shows a racking mechanism including a threaded shaft and mounting plate in exploded view;

FIG. 11 shows the racking mechanism of FIG. 10 with the threaded shaft fitted with the mounting plate shown in perspective from a back side of the mounting plate; and

FIG. 12 shows a racking mechanism of FIG. 11 in perspective view from a front side of the mounting plate.

FIG. 13 shows an arc-resistant cubicle in perspective view;

FIG. 14 shows the arc-resistant cubicle of FIG. 13 from a front view; and

FIG. 15 shows the arc-resistant cubicle of FIG. 13 from a top view section through line A-A.

### DETAILED DESCRIPTION OF THE PREFERRED EMBODIMENTS

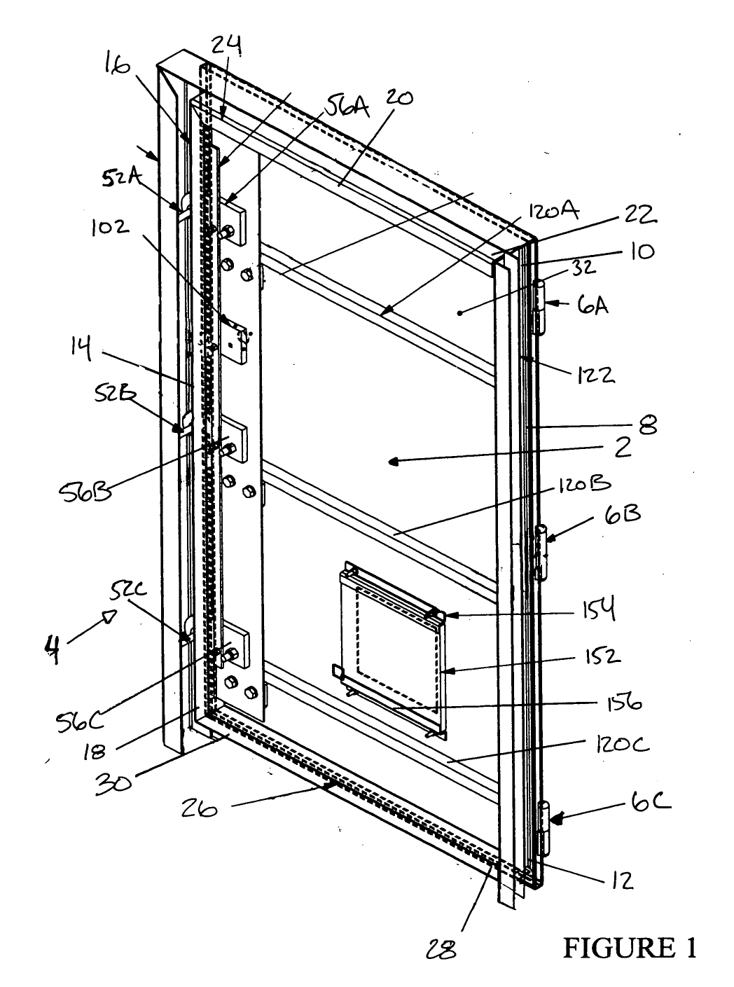

As shown in the preferred construction in FIG. 1, a door 2 is connected to a door case 4 by hinges 6. The door case 4 is suitable for positioning at an entrance to an electrical panel or circuit breaker cabinet, not shown. The door 2 is movable between open and closed positions, the closed position being shown in FIG. 1. When in the closed position, the door 2 seals the entrance to the electrical panel from the area surrounding the entrance from any gas or vapour exiting therefrom.

The door 2 has an internal door frame comprised of an elongated tubular metal hinge side member 8 having a top end 10 and a bottom end 12 for vertical positioning at a hinge side of the door 2. A similar elongated tubular metal latch side member 14 has a top end 16 and a bottom end 18 for vertical positioning at a latch side of the door 2.

A tubular elongated metal top member 20 having a proximal end 22 and a distal end 24. The top member 20 is positioned horizontally along a top of the door 2 with the top member proximal end 22 welded to the top end 10 of the hinge side member 8, and the top member distal end 24 welded to the top end 16 of the latch side member 14. A tubular elongated metal bottom member 26 has a proximal end 28 and a distal end 30 and is positioned horizontally along the bottom of the door 2. The bottom member proximal end 28 is welded to the bottom end 12 of the hinge side member 8, and the bottom member distal end 30 is welded to the bottom end 18 of the latch side member 14.

While the connections of the ends metal hinge side member 8, latch side member 14, top member 20 and bottom member 26 are preferably formed with mitre cuts and are connected by weld joints, it is appreciated that other suitable means of connecting these members would also be suitable, for example corner brackets. Also, the metal hinge side member 8, latch side member 14, top member 20 and bottom member 26 are preferably made of steel.

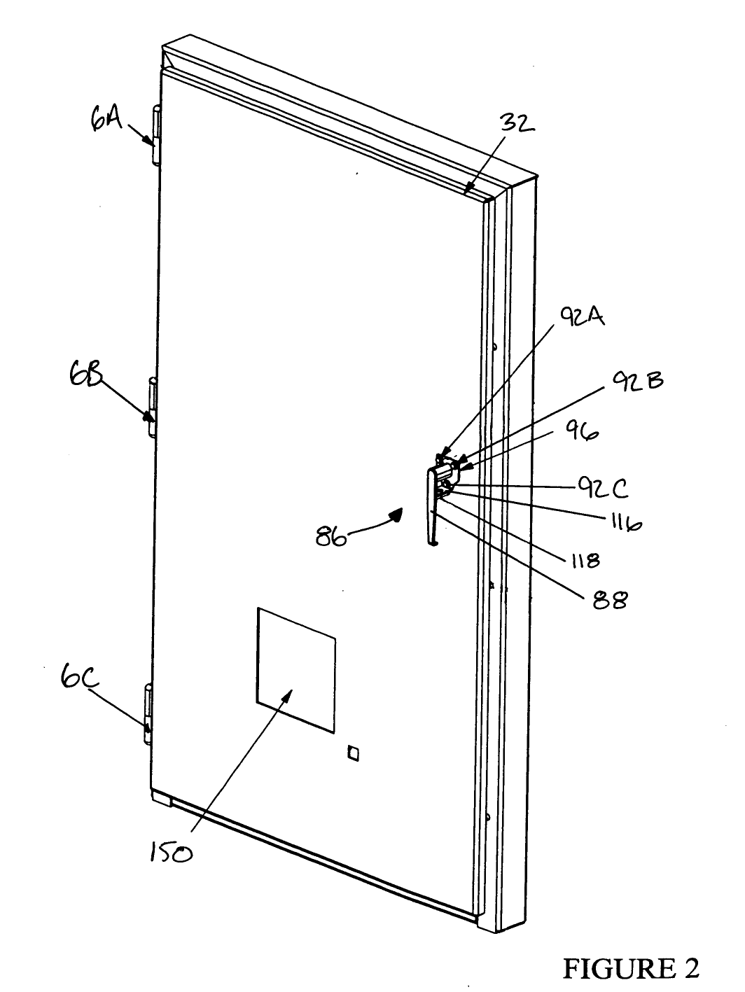

A door skin 32 forming a covering is connected at an outer side of the hinge side member 8, latch side member 14, top member 20 and bottom member 26 to provide a covering for the door 2. The door skin 32 is shown more clearly on the door 2 in FIG. 2. Preferably, the door skin 32 is a metal sheet or plate and is made of steel.

The dimensions of the door 2 depend on the size of the arc-resistant switchgear cabinet which varies depending on the voltage and current rating. In a conventional embodiment, the door 2 has a width between 29 to 48 inches and a height between 40 and 90 inches.

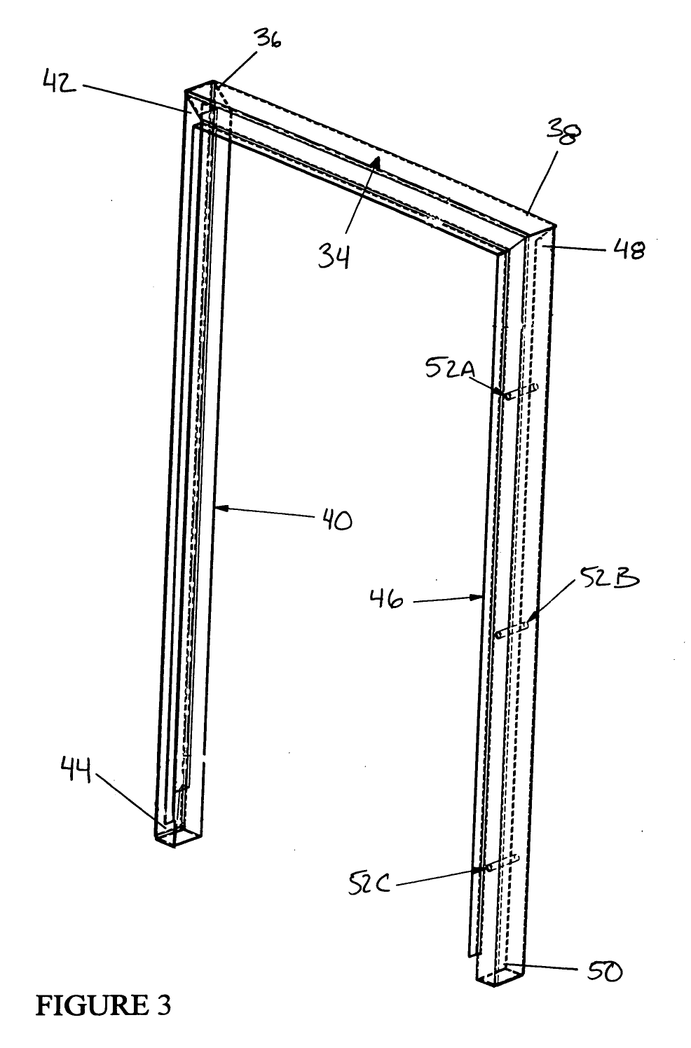

As shown in FIG. 1, the door 2 is hingedly attached to the door case 4 so as to move between open and closed positions. The door case 4 is shown in FIG. 3 and is comprised of elongated metal channel members which are welded together. An elongated casing top channel 34 is provided at a top of the door case 4. The casing top channel 34 has a proximal end 34 and a distal end 36. An elongated casing hinge side channel member 40 extends vertically at a hinge side of the door case 4 and has an upper end 42 and a lower end 44. Similarly, an elongated casing latch side channel member 46 extends vertically at a latch side of the door case 4 and has an upper end 48 and a lower end 50.

The door case 4 is formed by connecting the proximal end 36 of the casing top channel member 34 to the upper end of the casing hinge side channel member 40. The distal end 38 of the casing top channel member 34 is connected to the upper end 48 of the casing latch side channel member 46. Preferably, the proximal end 36 and distal end 38 and upper ends 42 and 48 are formed with mitre cuts and weld joints although it is appreciated that other suitable fastening means could be used.

The door 2 is connected to the door case 4 by three hinges 6A, 6B and 6C which are welded to the casing hinge side channel member at intervals spaced along a vertical length thereof. The hinges 6A, 6B and 6C are also welded to the door hinge side member 8.

As shown in FIG. 3, three pins 52A, 52B and 53C are positioned horizontally in the casing latch side channel member 46 and spaced at a vertical distance from one another. A latching mechanism 54 is provided on the door 2 and has three latch hooks 56A, 56B and 56C which engage the three pins 52A, 52B and 52C, respectively when the door 2 is locked.

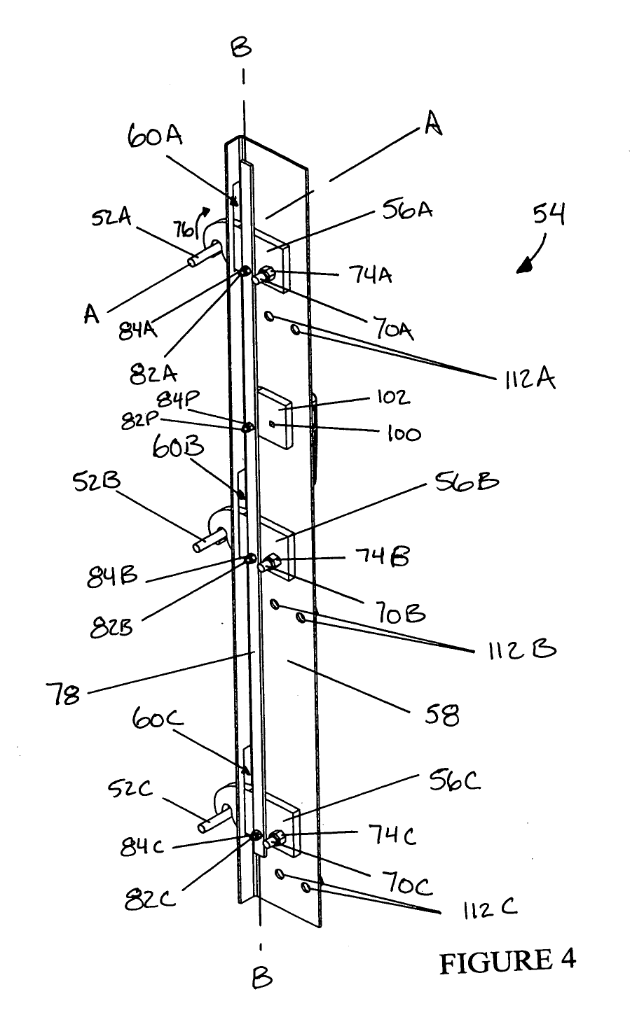

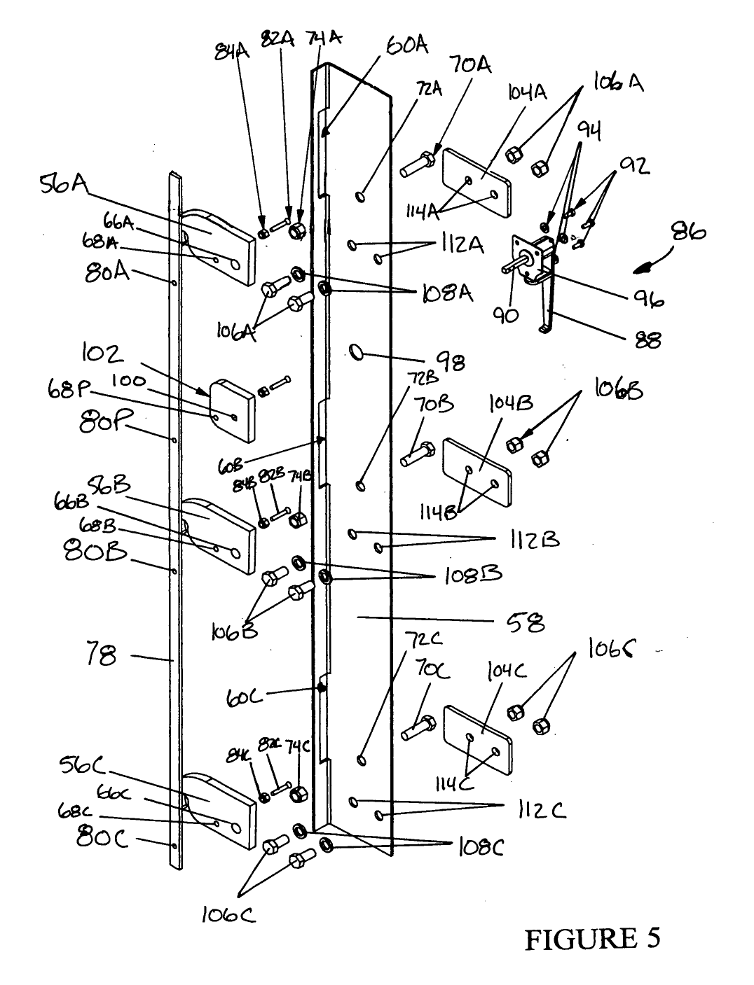

The latching mechanism is shown in FIGS. 4 and 5. The latch hooks 56A, 56B and 56C are mounted on a latching mechanism base 58 which is a rectangular plate which has, at one edge, a strip of the base 58 which is bent orthogonal to a plane of the base 58. The strip has slots 60A, 60B and 60C through which the respective latch hooks 56A, 56B and 56C are positioned.

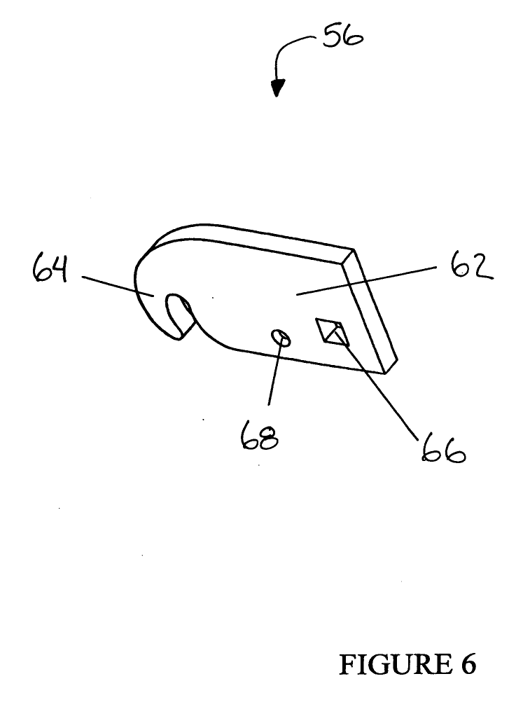

One latch hook 56 is shown in FIG. 6. The latch hook 56 is formed from a plate of metal and has a latch body 62 at one end and a latch hook end 64 at an opposite end. The latch body 62 has a latch hook mounting hole 66, for mounting the latch hook 56 to the base 58. The latch body 62 also has a link bar mounting hole 68 beside the latch hook mounting hole 66 at a position closer to the latch hook end 64.

As shown in the exploded view in FIG. 5, Latch hook 56A is pivotably attached to the latching mechanism base 58 by a latch hook bolt 70 which is passed through a latch hook hole 72 punched or drilled through the base 58. The latch hook 56A is positioned with the latch hook end 64 passed through slot 60A and is pivotably attached to the base 58 by passing the latch hook bolt 72 through the latch hook mounting hole 68 on the latch hook body 62 and screwing a threaded latch hook nut 74 thereon. By the pivotal mounting of the latch hook 56A on the latching mechanism base 58 and with the latch hook end 64A positioned through slot 60A, the latch hook 56A can pivot through the slot in a direction of arrow 76 shown in FIG. 4. The direction of travel of the latch hook 56A is through a plane orthogonal to a longitudinal axis A-A of pin 52A. Thus, the latch hook 56A can selectively engage and disengage pin 52A.

Each of latch hooks 56B and 56C are pivotally attached to the base 58 as has been described with reference to latch hook 56A.

As shown on FIG. 5, the latch hooks 56A, 56B and 56C are also connected to a link bar 78. The link bar 78 is an elongated metal bar having three link bar holes 80A, 80B and 80C drilled there through. The link bar holes 80A, 80B and 80C are drilled at a spacing selected in-line with the link bar mounting holes of the respective latch hooks 56A, 56B and 56C.

The attachment of the link bar 78 should be done before the attachment of the latch hooks 56A, 56B and 56C are attached to the base 58. The attachment of the link bar 78 will be described with respect to latch hook 56A. A link bar bolt 82 is passed through the link bar mounting hole 68 from a side of the latch hook 56A that will be facing the base 58 when the latching mechanism 54 is assembled. The link bar bolt 82 is then passed through the link bar hole 80A of the latch body 62 and a threaded link bar nut 84 is fastened thereon.

As shown in FIG. 4, moving the link bar 78 in a direction of a longitudinal axis B-B, the latch hooks 56A, 56B and 56C are moved through the respective slots 60A, 60B and 60C selectively engaging the respective pins 52A, 52B and 52C.

A door handle 86 is provided to move the link bar 78. As shown in FIG. 5, the door handle has a lever 88, which can be gripped by a user, and a handle post 90 which is rotated corresponding to a rotation of the lever 88. The handle post 90 has a square cross-sectional shape.

As shown in FIG. 2, the door handle 86 is mounted to the door skin 32 using three mounting bolts 92 fastened through holes in a handle mounting plate 96. Three flat washers 94 are placed between the head of the respective mounting bolts 92 and the handle mounting plate 96.

When the door handle 86 is mounted on the door skin 32, the handle post 90 projects through a handle post aperture 98 on the latching mechanism base 58. The handle post 90 projects through a post hole 100 on a handle post plate 102 at a side of the latching mechanism base 58 opposite to the door skin 32. The post hole 100 has a square shape corresponding to the square cross-sectional shape of the handle post 90. Thus, the handle post 90 mates with and engages the post hole 100, such that rotation of the post 90 causes the handle post plate 102 to rotate.

The post plate 102 is also connected to the link bar 78 using a link bar bolt 82P fitted through a link bar hole and a link bar nut 84P, in a similar manner as the latch hooks 56A, 56B and 56C are fixed, as shown in FIG. 5.

Before mounting the door handle 86, the latching mechanism base 58 is attached to the door 2 using three door mounting latch plates 104A, 104B and 104C. The door mounting latch plates 104A, 104B and 104C are positioned on a side of the door skin 32 at a side opposite to a side which the latching mechanism base 58 is to be attached. Three sets of mounting latch plate bolts 106A, 106B and 106C, each having lock washers 108A, 108B and 108C thereon, are positioned through three respective pairs of mounting apertures 112A, 112B and 112C on the latching mechanism base 58. The latching mechanism base 58 is positioned at the door skin 32 and holes, not shown, are drilled through the door skin 32, at locations corresponding to the mounting apertures 112A, 112B and 112C. The three sets of mounting latch plate bolts 106A, 106B and 106C are positioned through the holes in the door skin 32 and through corresponding pairs of mounting latch plate holes 114A, 114B and 114C in the three door mounting latch plates 104A, 104B and 104C, which are positioned at the opposite side of the door skin 32. Three sets of threaded mounting latch plate nuts 110A, 110B and 110C are screwed onto the respective mounting latch plate bolts 106A, 106B and 106C, to secure the latching mechanism to the inside of the latch edge of the door 2.

Thus, when a user turns the door handle lever 88, the door handle post 90 rotates to, in turn, rotate the handle post plate 102 to move the link bar 78 up or down through axis B-B. This movement of the link bar 78 causes each of the latch hooks 56A, 56B and 56C to rotate to selectively engage or disengage the respective pins 52A, 52B and 52C. Thus the door 2 can be locked, where the latch hooks 56A, 56B and 56C engage or hook around the respective pins 52A, 52B and 52C, and unlocked, where the latch hooks 56A, 56B and 56C disengage or are unhooked from the respective pins 52A, 52B and 52C.

As shown on FIG. 2, the door handle lever 88 has a lever locking tab 116 with an aperture there through. A corresponding mounting plate locking tab 118 is provided on the mounting plate, so that, when the door handle lever 88 is perpendicular, and the latch hooks 56A, 56B and 56C are engaged with corresponding Pins 52A, 52B and 52C, the apertures of the respective tabs 116 and 118 are aligned. The alignment of the apertures of the tabs 116 and 118, enables a lock, not shown, can be placed through the apertures to secure the door 2 from access unless the lock is removed.

As shown in FIG. 1, to enhance the structural integrity of the door 2, cross brace bars 120A, 120B and 120C are welded horizontally between the door hinge side member 8 and the door latch side member 14. The cross brace bars 120A, 120B and 120C are spaced from each other at longitudinal intervals of the door hinge side member 8 and the door latch side member 14 to provide additional strength to the frame of the door 2.

Also shown in FIG. 1, an overlapping angle 122 is wrapped around the casing hinge side channel member 40. The overlapping angle is preferably steel to create an overlap with the casing hinge side channel member 40 to provide additional structural strength to the hinge side of the door casing 4.

As shown in FIG. 2, the door skin 32 has a generally square aperture 150. The aperture 150 can be covered with a Plexiglas sheet 152 so that the inside of a cabinet can be visible by a user from the outside, but a seal can be maintained at the door 2. The Plexiglas sheet 152 is mounted to the door skin 32 using an upper window clamp 154 and a lower window clamp 156. The upper and lower window clamps 154 and 156 are formed by bending sheet metal steel plates to have a z-shaped profile. By fastening the upper and lower window clamps 154 and 156, respectively, to an inside of the door skin 32 horizontally at an upper and lower edge of the aperture 150, the Plexiglas sheet 152 can be slidably inserted between the upper and lower window clamps 154 and 156, respectively, to cover the aperture 150.

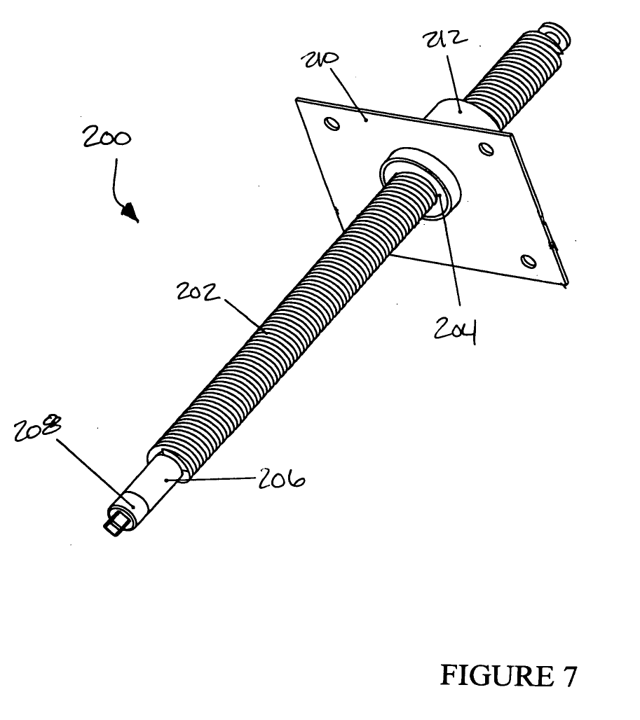

Shown in FIG. 7 is a screw raking mechanism 200. The screw racking mechanism 200 has a threaded shaft 202 screwed through a hub 204 having corresponding threads. The threaded end 202 has a racking end 206 with a socket adapter 208, preferably one-half inch, fixed thereto. The socket adapter 208 can be fitted with ratchet sockets of various sizes, not shown, to activate and deactivate various types of breakers.

The diameter and length of the threaded shaft 202 varies depending on the size and weight of the breaker, which can be between 300 and 4000 lbs. The diameter of the threaded shaft can range from 2 inches to 3 inches in a conventional embodiment. In a conventional embodiment, the length of the threaded shaft 202 is equal to the distance between the switchgear door to the breaker plus 12 inches. In a typical embodiment, the distance between the door and breaker is between 7 inches and 20 inches.

The hub 204 is fixed at an aperture through a racking mechanism mounting plate 210. At an opposite side of the mounting plate 210, a hollow cylindrical hub support 212 is provided such that the threaded shaft 202 is screwed through the hub 204, and the hub is fitted in the hub support 212, so that the threaded shaft 202 extends through both sides of the plate 210.

The racking mechanism mounting plate 210 can be fixed to the door 2, although not shown, to provide “thru-the-door” racking so that a user can operate various breakers from outside an electrical cabinet. In a more preferred form, the threaded racking bar 202 can be screwed through a threaded hole in the door 2 as a more simplified construction.

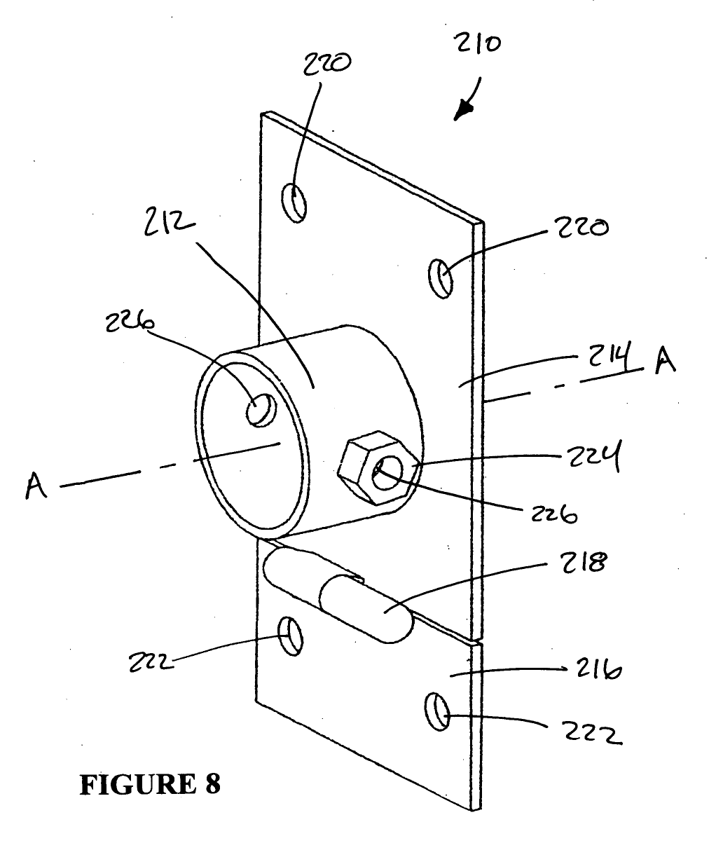

FIG. 8 shows a racking mechanism mounting plate 210 which comprises a first plate portion 214 and a second plate portion 216 connected by a hinge 218. The hinge 218 enables manipulation of the first plate portion 214 with respect to the second plate portion 216 to adjust an angle of axis A-A extending through a centre axis of the hub support 212.

The mounting plate 210 can be fixed to a door of an electrical cabinet using fastening means, for example screws or bolts (not shown), which are positioned through the first and second pairs of mounting holes 220 and 222, on the respective first and second mounting plates 214 and 216. To enable the tilting of the first mounting plate 214 by the hinge 218, the fasteners used to fix the first mounting plate 214 to the door through mounting holes 220 can be loosened. Preferably, wing nuts are fastened on bolts positioned through the first pair of mounting holes 220 so that a user can selectively loosen and tighten the first mounting plate 214. By loosening the fasteners securing the first mounting plate 214, the first mounting plate 214 and therefore hub 204 and threaded shaft 202 can be selectively tilted from a substantially horizontal plane towards a vertical plane. While the required degree of tilting of the threaded shaft 202 to selectively connect and disconnect a breaker varies depending on the size of breaker and distance from the door to the breaker. In a conventional embodiment, the degree of tilting is preferably 15 degrees at a minimum.

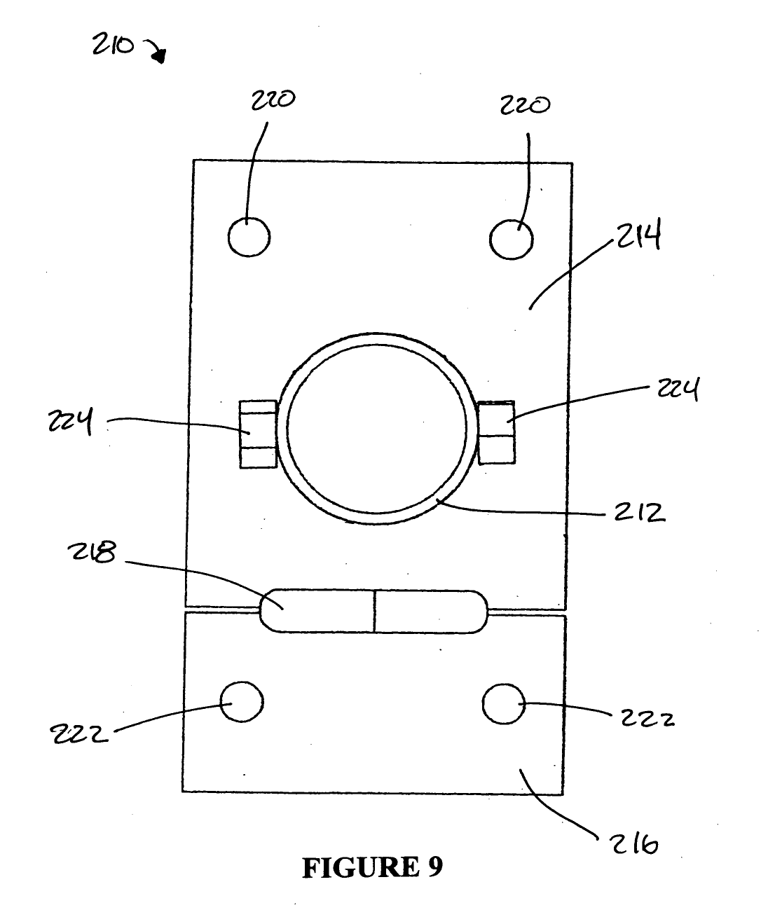

FIG. 9 shows the mounting plate of FIG. 8 in top view. As shown in both of FIGS. 8 and 9, the hub support 212 is provided with two hub positioning nuts 224 fixed to the sides of the hub support 212. As shown in FIG. 8, two hub support holes 226 are formed at the same location as the hub mounting nuts 224. As shown in FIG. 9, a hub hole 213 is formed on the first plate portion 214 so that the hollow cylindrical hub support 212 is accessible at both ends thereof.

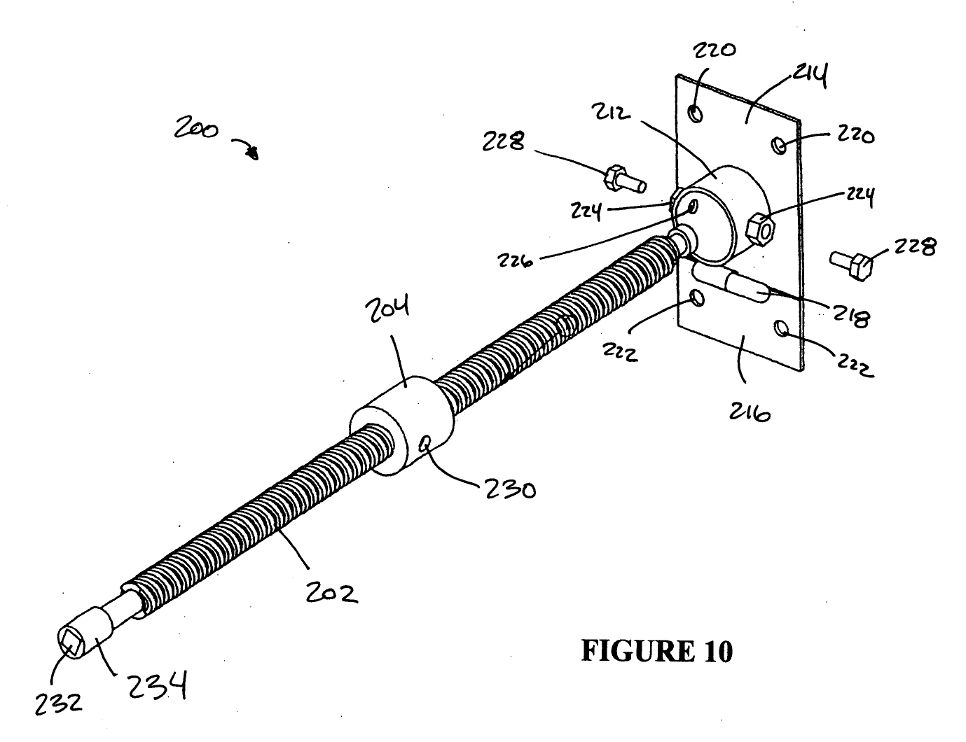

As can be seen in the exploded view in FIG. 10, two hub mounting screws 228 can be threadably secured in the respective hub mounting nuts 224 to be positioned within respective hub holes 230 formed on the sides of the hub 204, to thereby secure the hub 204 within the hub support 212.

As can be envisaged from FIG. 10, to assemble the screw racking mechanism 200, the hub 204 is threaded onto the threaded shaft 202 and the cylindrical hub 204 is positioned within the cylindrical channel of the hub support 212. Hub mounting screws 228 are screwed into hub mounting nuts 224 to engage within hub holes 230 of the hub 204.

The threaded shaft 202 can then be threadably moved within the hub 204 by a user, for example using a wrench or a speed wrench (not shown) which is inserted into a socket 232 at a user end 234 of the threaded shaft 202.

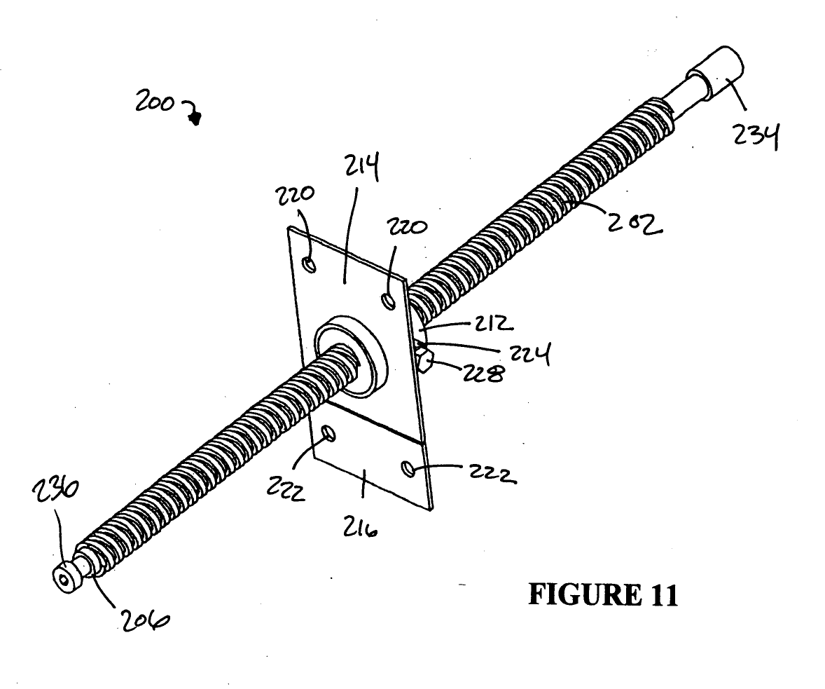

FIG. 11 shows the screw racking mechanism 200 in perspective view from a back side of the racking mechanism mounting plate 210. As shown in FIG. 11, the racking end 206 has a custom socket 236 fitted thereto.

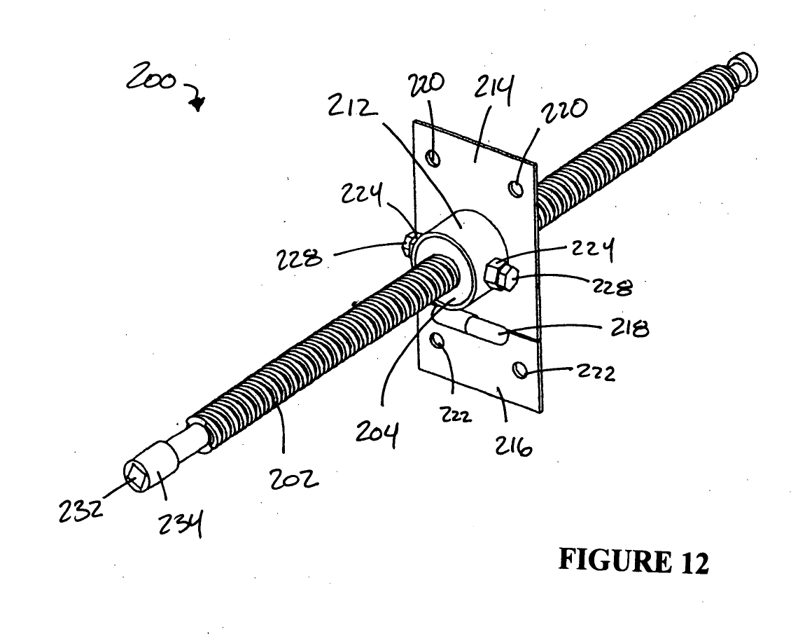

FIG. 12 shows the screw racking mechanism 200 assembled and in perspective view.

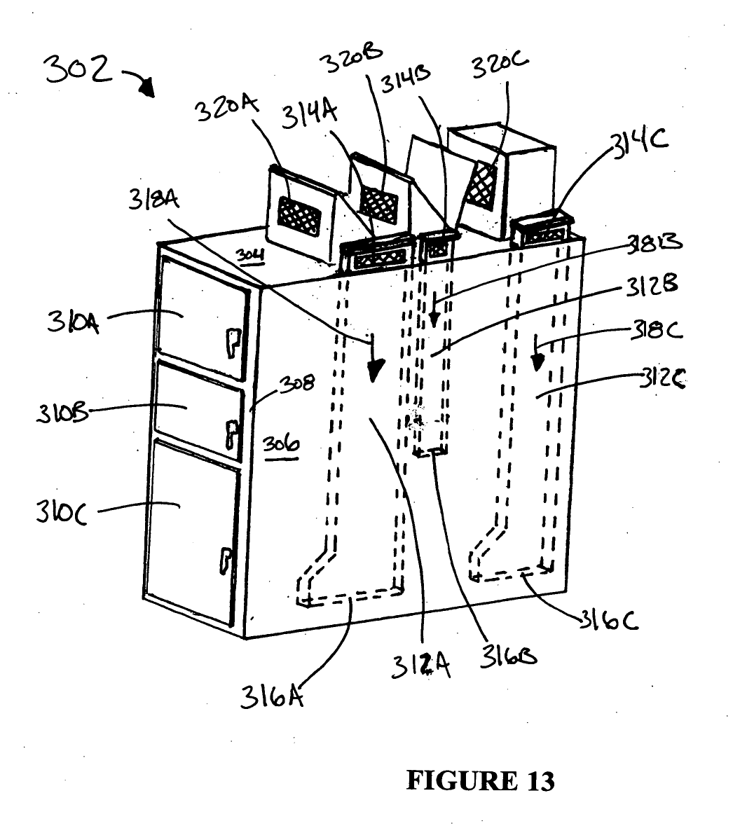

FIG. 13 shows an arc-resistant switchgear cubicle 302 which houses electrical equipment (not shown). The arc-resistant switchgear cubicle 302 has a planar top surface 304, a planar side surface 306 and a planar front surface 308. A second planar side surface, a planar bottom surface and a planar back surface are not shown, but exist to provide an enclosed cubicle.

As shown, the front surface 308 has three access doors 310A, 310B and 310C which can be opened to access the interior of the arc-resistant switchgear cubicle. The doors 310A, 310B and 310C can be designed as the aforementioned door 2 and all of its features and locking assembly, in a preferred embodiment.

Also shown are three insulated ventilation shafts 312A, 312B and 312C. The insulated ventilation shafts 312A, 312B and 312C are preferably insulated with a rigid insulation such as dense styrofoam insulation panels adhered to an outside surface of the ventilation shafts using adhesive or other suitable mechanical fasteners. The three insulated ventilation shafts 312A, 312B and 312C have respective inlets 314A, 314B and 314C, and respective outlets 316A, 316B and 316C. The inlets 314A, 314B and 314C are provided at a top of the insulated ventilation shafts 312A, 312B and 312C, and are shown as being positioned at the top surface 304 of the arc-resistant switchgear cubicle 302. The outlets 316A, 316B and 316C are provided at a lower end of the insulated ventilation shafts 312A, 312B and 312C, as shown.

To cool the arc-resistant switchgear cubicle 302, cooling air is drawn in through the inlets 314A, 314B and 314C, flows through the insulated ventilation shafts 312A, 312B and 312C, as indicated by arrows 318A, 318B and 318C, and then enters the arc-resistant switchgear cubicle 2 through the outlets 316A, 316B and 316C. Because the ventilation shafts 312A, 312B and 312C are insulated, the cooling air remains cool while being drawn through the insulated ventilation shafts 312A, 312B and 312C.

After entering the arc-resistant switchgear cubicle 302, the cooling air mixes with the hot air inside the arc-resistant switchgear cubicle 302 to provide cool air to the arc-resistant switchgear cubicle 302. Hot air is generated by the electrical parts (not shown). The mixing of cooling air generates warm exhaust air flows upwards through the arc-resistant switchgear cubicle 302, to exit the arc-resistant switchgear cubicle 302 via respective blow vents 320A, 320B and 320C positioned at the top surface 304 of the arc-resistant switchgear cubicle 302.

The cooling air flow is established by convection currents and therefore there is no requirement for a fan or other means to direct the air flow. Because the cooling air enters into the insulated ventilation shafts 312A, 312B and 312C to be introduced into the interior of the arc-resistant switchgear cubicle 302, at a bottom thereof, the mixing of the cooling air with warm air inside the arc-resistant switchgear cubicle 302, generates warmer air which, by its nature, flows upwards to exit the arc-resistant switchgear cubicle 302 through blow vents 320A, 320B and 320C.

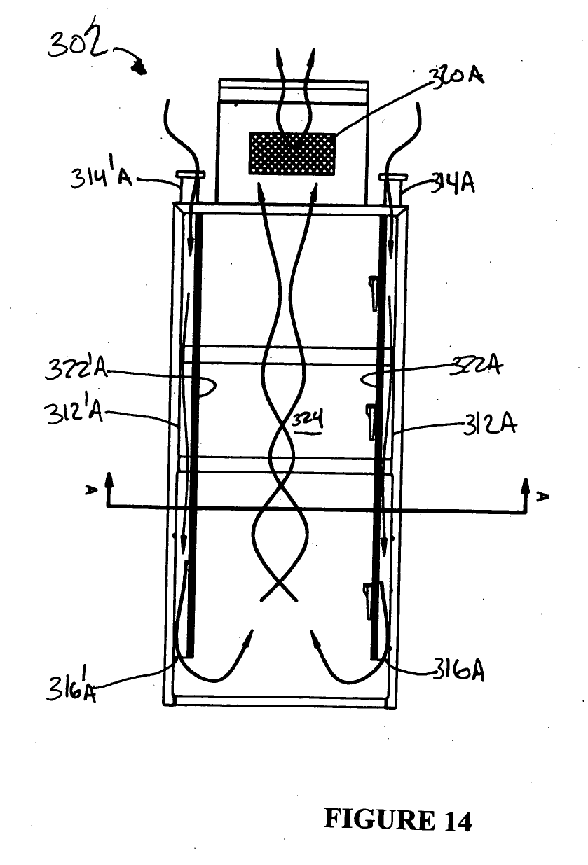

FIG. 14 shows the arc-resistant cubicle 302 of FIG. 13 however an additional insulated ventilation shaft 312′A is shown as longitudinally extending along a side of the cubicle 302 opposite the surface 306. Thus, two insulated ventilation shafts 312A and 312′A are provided with inlets 314A and 314′A and outlets 316A and 316′A, respectively. Each of the insulated ventilation shafts 312A and 312′A has insulation 322A and 322′A provided longitudinally along each of the insulated ventilation shafts 312A and 312A, as shown.

FIG. 14 illustrates the flow of cooling air into and through the cubicle 302. As shown by the arrows, the cooling air enters the ventilation shafts 312A and 312′A through inlets 314A and 314′A, respectively. The cooling air travels downwardly through the insulated ventilation shafts 312A and 312′A and enters into the cubicle 302 through the outlets 316A and 316′A. The cooling air then mixes with the warm air in the cubicle 302 in the mixing zone generally indicated as 324. The mixed cooling air with the warm air inside the cubicle 302 generates warmer exhaust air which travels upwardly through the interior of the cubicle 302 and exits from the top of the cubicle 302 through the blow vent 320A.

The flow of air is established by the convection current created by the rising warmer air which in turn draws the cooler cooling air into the cubicle 302.

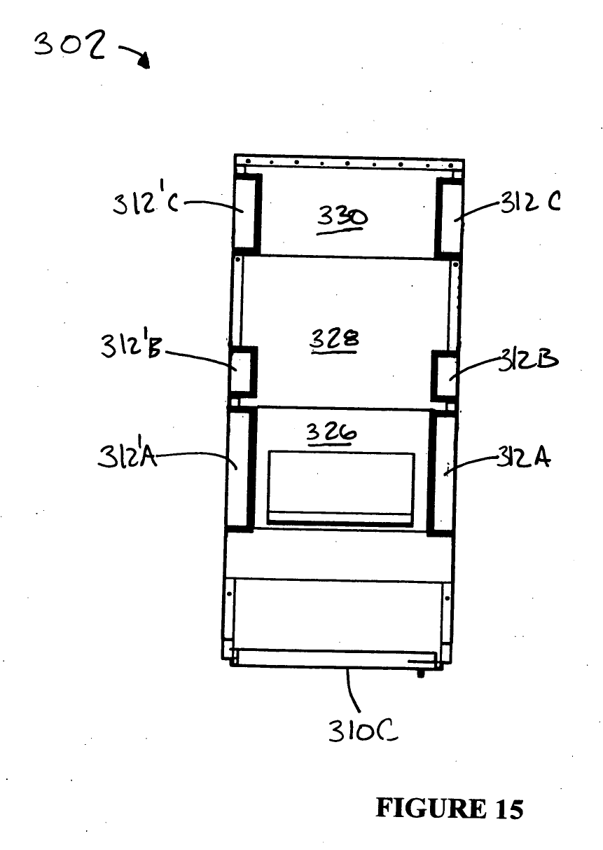

FIG. 15 is a sectional view of the cubicle 302 through section A-A shown in FIG. 14. As shown in FIG. 15, three compartments are provided within the cubicle 302, being a first compartment 326, a second compartment 328 and a third compartment 330. Each of the compartments 326, 328 and 330 is separated from the adjacent compartment so as to form segregated independent sections. As shown, the insulated ventilation ducts 312A and 312′A are provided to cool the first compartment section 26, insulated ventilation ducts 312B and 312′B are provided to cool the second compartment section 328 and insulated ventilation ducts 312C and 312′C are provided to cool the third compartment section 330.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

The embodiments of the invention in which an exclusive property or privilege is claimed is defined as follows:

1. A door for sealing an opening to an electrical panel,
said door comprising a supporting frame and a door skin connected to a side of the supporting frame, the supporting frame comprising:
an elongated hinge side member having a top end and a bottom end,
an elongated latch side member having a top end and a bottom end,
a top member having a proximal end and a distal end, the top member proximal end being connected to the top end of the hinge side member and the top member distal end being connected to the upper end of the latch side member, and
a bottom member having a proximal end and a distal end, the bottom member proximal end being connected to the bottom end of the hinge side member and the bottom member distal end being connected to the bottom end of the latch side member,
the door further comprising a latching mechanism to lock the door to a door casing,
the latching mechanism comprising at least one latch hook having a latch body and a latch hook end, the latch body being connected to a latching mechanism base at a first side of the latch hook and connected to a linkage member at a second side of the latch hook at a position on the latch body spaced laterally from the attachment to the latching mechanism base so that movement of the linkage member in an upward or downward direction causing the latch hook to pivot through a plane parallel to a to engage or disengage a pin provided in a channel of a door frame,
the latching mechanism base being mounted to the door at or near the hinge side member with at least one mounting latch plate and a fastener, and
the door further comprising a door handle having a handle lever and a post orthogonally connected thereto, the door handle being mounted on the door skin with the elongated post passing through an aperture in the door skin and an aperture in the latching mechanism base, the post mating with a hole in a post plate which is connected to the linkage member at a position above or below a position of an attachment of the latch hook to the linkage member,
such that turning the door handle lever moves the linkage member to selectively engage or disengage the at least one latch hook on a respective at least one pin of a door case.

2. The door of claim 1, wherein the latching mechanism comprises three latch hooks spaced vertically along the latching mechanism base.

3. The door of claim 1, wherein at least one cross brace member is provided in the support frame, the at least one cross brace having a proximal end and a distal end, the proximal end being connected to the hinge side member and the distal end being connected to the latch side member.

4. The door of claim 1, wherein the hinge side member, the latch side member, the top member and the bottom member are made of steel.

5. The door of claim 4, wherein the door skin is a steel sheet.

6. The door of claim 1, wherein a racking mechanism is provided through the door skin, the racking mechanism comprising a threaded shaft engageable with a threaded hole through the door skin.

7. A racking mechanism mountable to a door comprising:
a threaded shaft having a racking end and a user end, and
a mounting plate, the mounting plate having an aperture with a threaded hub positioned there through, the threaded shaft being movable through the hub to extend the racking end closer and further from the mounting plate.

8. The racking mechanism of claim 7, wherein the mounting plate has a second plate hingedly attached to the mounting plate so that an axis of the threaded shaft can be adjusted.

9. The racking mechanism of claim 7, wherein the racking end has a socket adapter connected thereto.

10. The racking mechanism of claim 7, wherein the user end has a socket fixed thereto for connection with a wrench.

11. A racking mechanism mountable to a door comprising:
a threaded shaft having a racking end and a user end, the racking end having a socket adapter connected thereto and the user end having a socket adapted to connect with a wrench;
a first mounting plate having at least one mounting hole and a second mounting plate having at least one mounting hole, the first and second mounting plates being hingedly connected;
a hollow cylindrical hub support is fixed to the first mounting plate and a hub hole is formed through the first mounting plate so that the hub support is accessible at both ends and provides a hollow cylindrical channel; and
a cylindrical hub having a threaded core is threadably movable on the threaded shaft and the hub is securable within the hollow cylindrical channel of the hub support.

12. A door for sealing an opening to an electrical panel,
said door comprising a supporting frame and a door skin connected to a side of the supporting frame, the supporting frame comprising:
an elongated hinge side member having a top end and a bottom end,
an elongated latch side member having a top end and a bottom end,
a top member having a proximal end and a distal end, the top member proximal end being connected to the top end of the hinge side member and the top member distal end being connected to the upper end of the latch side member, and
a bottom member having a proximal end and a distal end, the bottom member proximal end being connected to the bottom end of the hinge side member and the bottom member distal end being connected to the bottom end of the latch side member,
the door further comprising a latching mechanism to lock the door to a door casing,
the latching mechanism comprising at least one latch hook having a latch body and a latch hook end, the latch body being connected to a latching mechanism base at a first side of the latch hook and connected to a linkage member at a second side of the latch hook at a position on the latch body spaced laterally from an attachment to the latching mechanism base so that movement of the linkage member in an upward or downward direction causing the latch hook to pivot through a plane parallel to a to engage or disengage a pin provided in a channel of a door frame,
the latching mechanism base being mounted to the door at or near the hinge side member with at least one mounting latch plate and a fastener, and
the door further comprising a door handle having a handle lever and a post orthogonally connected thereto, the door handle being mounted on the door skin with the elongated post passing through an aperture in the door skin and an aperture in the latching mechanism base, the post mating with a hole in a post plate which is connected to the linkage member at a position above or below a position of an attachment of the latch hook to the linkage member,
such that turning the door handle lever moves the linkage member to selectively engage or disengage the at least one latch hook on a respective at least one pin of a door case,
the door further having a threaded aperture through which a racking mechanism is positioned, the racking mechanism comprising a threaded shaft having a racking end and a user end.

13. An air cooling system for an arc-resistant switchgear cubicle, wherein:
at least one insulated ventilation shaft is positioned longitudinally at a side of the cubicle, the at least one insulated ventilation shaft having an inlet at an upper end and an outlet at a lower end;
at least one blow vent is provided at a top of the cubicle; and
whereby cold air is drawn into the cubicle through the inlet of the at least one insulated ventilation shaft and enters the cubicle through the outlet, and warm air is exhausted from the cubicle through the at least one blow vent, the flow of air being generated by convection current.

14. The air cooling system of claim 13, wherein rigid insulation board is fixed to an outside surface of the at least one insulated ventilation shaft.

15. An air cooling system for an arc-resistant switchgear cubicle having three sections formed by vertically disposed walls within the cubicle, wherein:
each section has two insulated ventilation shafts, each shaft being positioned longitudinally at each side wall of the section, each insulated ventilation shaft having an inlet at an upper end and an outlet at a lower end;
one blow vent is provided at a top surface of the section; and
whereby cold air is drawn into each cubicle section through the inlets of the insulated ventilation shafts and enters the cubicle section through the outlets, and warm air is exhausted from each cubicle section through the blow vent, the flow of air being generated by convection current.
